(19) United States
(12) Patent Application Publication
(10) Pub. No.: US 2017/0328213 A1
(43) Pub. Date: Nov. 16, 2017

(54) ENGINE COMPONENT WALL WITH A COOLING CIRCUIT

(71) Applicant: General Electric Company, Schenectady, NY (US)

(72) Inventor: Ronald Scott Bunker, West Chester, OH (US)

(21) Appl. No.: 15/152,862

(22) Filed: May 12, 2016

(51) Int. Cl. F01D 5/18; F01D 25/12; F04D 29/32; F04D 29/54; F23R 3/06; F01D 5/14; F04D 29/58; F01D 9/04; F23R 3/00

(52) U.S. Cl. CPC F01D 5/186; F01D 9/041; F01D 25/12; F04D 29/324; F23R 3/002; F23R 3/06; F01D 5/147; F04D 29/582; F04D 29/542; F05D 2250/70; F05D 2260/202; F05D 2260/221; F05D 2220/32

(57) ABSTRACT

An apparatus and method for flowing cooling air through an outer wall of an engine component such as an airfoil. The airfoil having the outer wall can include a skin layer and a porous layer. The skin layer can include a skin cooling circuit for providing the cooling air from an interior of the airfoil to the exterior of the airfoil through the porous layer.

### BACKGROUND OF THE INVENTION

Turbine engines, and particularly gas or combustion turbine engines, are rotary engines that extract energy from a flow of combusted gases passing through the engine onto a multitude of rotating turbine blades.

Gas turbine engines for aircraft, for example, are designed to operate at high temperatures to maximize engine efficiency, so cooling of certain engine components, such as the high pressure turbine, can be beneficial. Typically, cooling is accomplished by ducting cooler air from the high and/or low pressure compressors to the engine components that require cooling. Temperatures in the high pressure turbine are around 1000° C. to 2000° C. and the cooling air from the compressor is around 500° C. to 700° C. While the compressor air is a high temperature, it is cooler relative to the turbine air, and can be used to cool the turbine.

Contemporary turbine airfoils generally include one or more interior cooling passages for routing the cooling air through the airfoil to cool different portions, such as the walls of the airfoil. Often, film holes are used to provide the cooling air from the interior cooling passages to form a surface cooling film to separate the hot air from the airfoil. However, the film holes provide the surface cooling film to a discrete, local portion of the airfoil and require a large flow to maintain proper surface cooling over an area of the airfoil exterior surface.

### BRIEF DESCRIPTION OF THE INVENTION

In one aspect, embodiments of the invention relate to an airfoil for a turbine engine including an outer wall having an outer surface and an inner surface bounding an interior space. The outer wall defines a pressure side and a suction side extending axially between a leading edge and a trailing edge and extending radially between a root and a tip. The airfoil further includes a skin layer provided on an exterior of the outer surface, at least one porous layer provided on an outer surface of the skin layer, at least one skin cooling circuit including at least one channel formed in the skin layer and fluidly coupled to the porous layer, and at least one cooling air supply circuit located within the interior and fluidly coupled to the at least one channel.

In another aspect, embodiments of the invention relate to an engine component for a turbine engine, which generates a hot fluid flow, and provides a cooling fluid flow, includes a wall separating the hot fluid flow from the cooling fluid flow. The wall further includes a first surface along with the hot fluid flow in a hot flow path and a second surface facing the cooling fluid flow. The engine component further includes a skin layer provided on an exterior of the first surface, at least one porous layer provided on an outer surface of the skin layer, and at least one skin cooling circuit comprising at least one channel formed in the skin layer. The cooling fluid flow is fluidly coupled to the porous layer through the channel of the skin layer.

In yet another aspect, embodiments of the invention relate to a method of cooling an airfoil including passing a cooling airflow through an interior of the airfoil to a channel in a skin layer, and then to a porous layer overlying the skin layer.

### BRIEF DESCRIPTION OF THE DRAWINGS

In the drawings:

FIG. 1 is a schematic, cross-sectional view diagram of a gas turbine engine for an aircraft.

FIG. 2 is a perspective view of an engine component in the form of an airfoil as a blade of the turbine engine of FIG. 1.

FIG. 3 is a cross-sectional view of the airfoil of FIG. 2 including a two-layer wall.

FIG. 4 is a cross-sectional view of a wall of the airfoil of FIG. 2, having a skin layer and a porous layer, according to an embodiment of the invention

FIG. 5 is a cross-sectional view of the wall of FIG. 4, illustrating a flow of fluid through the skin layer and the porous layer.

FIG. 6 is a cross-sectional view of the wall of the airfoil of FIG. 2, having channels of the skin layer adjacent to the skin layer, according to another embodiment of the invention.

FIG. 7 is a cross-sectional view of the wall of the airfoil of FIG. 2, having channels connected by intermediate conduits, according to another embodiment of the invention.

FIG. 8 is a cross-sectional view of the wall of the airfoil of FIG. 2, having a portion of the porous layer disposed within the channels, according to another embodiment of the invention.

FIG. 9 is a cross-sectional view of the wall of the airfoil of FIG. 2, having shaped channels adjacent to the porous layer, according to another embodiment of the invention.

FIG. 10 is a cross-sectional view of the wall of the airfoil of FIG. 2, having channels formed at least partially within the porous layer, according to an embodiment of the invention.

### DESCRIPTION OF EMBODIMENTS OF THE INVENTION

The described embodiments of the present invention are directed to a wall of an engine component for providing a flow of cooling fluid to a hot surface. For purposes of illustration, the present invention will be described with respect to an airfoil for the turbine of an aircraft gas turbine engine. It will be understood, however, that the invention is not so limited and may have general applicability within an engine, including compressors, as well as in non-aircraft applications, such as other mobile applications and non-mobile industrial, commercial, and residential applications.

As used herein, the term “forward” or “upstream” refers to moving in a direction toward the engine inlet, or a component being relatively closer to the engine inlet as compared to another component. The term “aft” or “downstream” used in conjunction with “forward” or “upstream” refers to a direction toward the rear or outlet of the engine or being relatively closer to the engine outlet as compared to another component.

Additionally, as used herein, the terms “radial” or “radially” refer to a dimension extending between a center longitudinal axis of the engine and an outer engine circumference.

All directional references (e.g., radial, axial, proximal, distal, upper, lower, upward, downward, left, right, lateral, front, back, top, bottom, above, below, vertical, horizontal, clockwise, counterclockwise, upstream, downstream, forward, aft, etc.) are only used for identification purposes to aid the reader's understanding of the present invention, and do not create limitations, particularly as to the position, orientation, or use of the invention. Connection references (e.g., attached, coupled, connected, and joined) are to be construed broadly and can include intermediate members between a collection of elements and relative movement between elements unless otherwise indicated. As such, connection references do not necessarily infer that two elements are directly connected and in fixed relation to one another. The exemplary drawings are for purposes of illustration only and the dimensions, positions, order and relative sizes reflected in the drawings attached hereto can vary.

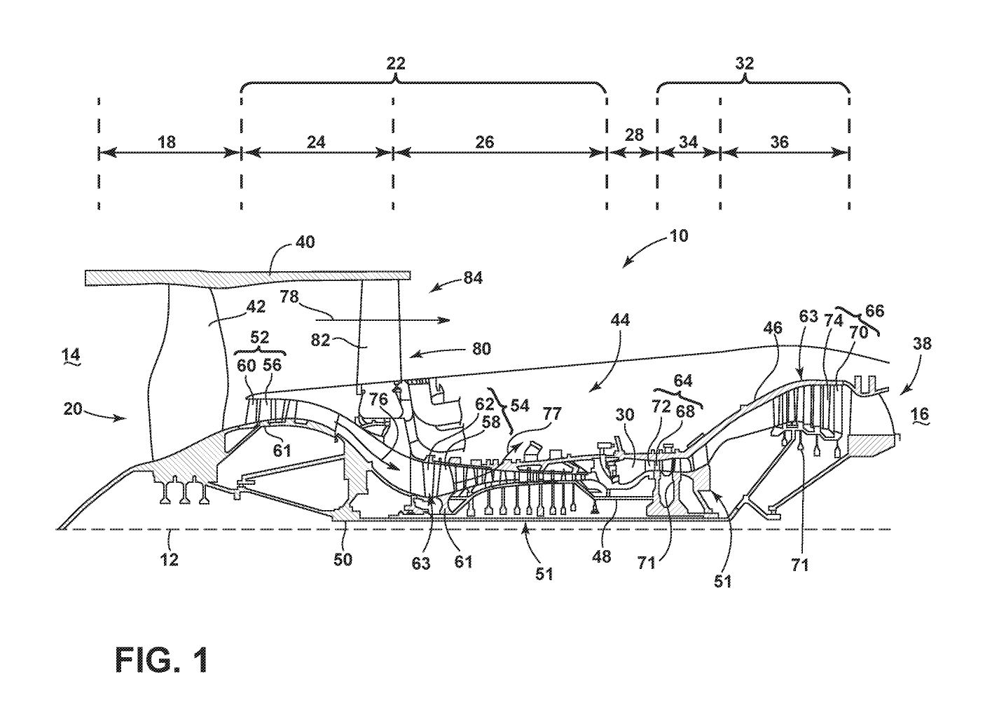

FIG. 1 is a schematic cross-sectional diagram of a gas turbine engine 10 for an aircraft. The engine 10 has a generally longitudinally extending axis or centerline 12 extending forward 14 to aft 16. The engine 10 includes, in downstream serial flow relationship, a fan section 18 including a fan 20, a compressor section 22 including a booster or low pressure (LP) compressor 24 and a high pressure (HP) compressor 26, a combustion section 28 including a combustor 30, a turbine section 32 including a HP turbine 34, and a LP turbine 36, and an exhaust section 38.

The fan section 18 includes a fan casing 40 surrounding the fan 20. The fan 20 includes a plurality of fan blades 42 disposed radially about the centerline 12. The HP compressor 26, the combustor 30, and the HP turbine 34 form a core 44 of the engine 10, which generates combustion gases. The core 44 is surrounded by core casing 46, which can be coupled with the fan casing 40.

A HP shaft or spool 48 disposed coaxially about the centerline 12 of the engine 10 drivingly connects the HP turbine 34 to the HP compressor 26. A LP shaft or spool 50, which is disposed coaxially about the centerline 12 of the engine 10 within the larger diameter annular HP spool 48, drivingly connects the LP turbine 36 to the LP compressor 24 and fan 20. The spools 48, 50 are rotatable about the engine centerline and couple to a plurality of rotatable elements, which can collectively define a rotor 51.

The LP compressor 24 and the HP compressor 26 respectively include a plurality of compressor stages 52, 54, in which a set of compressor blades 56, 58 rotate relative to a corresponding set of static compressor vanes 60, 62 (also called a nozzle) to compress or pressurize the stream of fluid passing through the stage. In a single compressor stage 52, 54, multiple compressor blades 56, 58 can be provided in a ring and can extend radially outwardly relative to the centerline 12, from a blade platform to a blade tip, while the corresponding static compressor vanes 60, 62 are positioned upstream of and adjacent to the rotating blades 56, 58. It is noted that the number of blades, vanes, and compressor stages shown in FIG. 1 were selected for illustrative purposes only, and that other numbers are possible.

The blades 56, 58 for a stage of the compressor can be mounted to a disk 61, which is mounted to the corresponding one of the HP and LP spools 48, 50, with each stage having its own disk 61. The vanes 60, 62 for a stage of the compressor can be mounted to the core casing 46 in a circumferential arrangement.

The HP turbine 34 and the LP turbine 36 respectively include a plurality of turbine stages 64, 66, in which a set of turbine blades 68, 70 are rotated relative to a corresponding set of static turbine vanes 72, 74 (also called a nozzle) to extract energy from the stream of fluid passing through the stage. In a single turbine stage 64, 66, multiple turbine blades 68, 70 can be provided in a ring and can extend radially outwardly relative to the centerline 12, from a blade platform to a blade tip, while the corresponding static turbine vanes 72, 74 are positioned upstream of and adjacent to the rotating blades 68, 70. It is noted that the number of blades, vanes, and turbine stages shown in FIG. 1 were selected for illustrative purposes only, and that other numbers are possible.

The blades 68, 70 for a stage of the turbine can be mounted to a disk 71, which is mounted to the corresponding one of the HP and LP spools 48, 50, with each stage having a dedicated disk 71. The vanes 72, 74 for a stage of the compressor can be mounted to the core casing 46 in a circumferential arrangement.

Complementary to the rotor portion, the stationary portions of the engine 10, such as the static vanes 60, 62, 72, 74 among the compressor and turbine section 22, 32 are also referred to individually or collectively as a stator 63. As such, the stator 63 can refer to the combination of non-rotating elements throughout the engine 10.

In operation, the airflow exiting the fan section 18 is split such that a portion of the airflow is channeled into the LP compressor 24, which then supplies pressurized air 76 to the HP compressor 26, which further pressurizes the air. The pressurized air 76 from the HP compressor 26 is mixed with fuel in the combustor 30 and ignited, thereby generating combustion gases. Some work is extracted from these gases by the HP turbine 34, which drives the HP compressor 26. The combustion gases are discharged into the LP turbine 36, which extracts additional work to drive the LP compressor 24, and the exhaust gas is ultimately discharged from the engine 10 via the exhaust section 38. The driving of the LP turbine 36 drives the LP spool 50 to rotate the fan 20 and the LP compressor 24.

A portion of the pressurized airflow 76 can be drawn from the compressor section 22 as bleed air 77. The bleed air 77 can be draw from the pressurized airflow 76 and provided to engine components requiring cooling. The temperature of pressurized airflow 76 entering the combustor 30 is significantly increased. As such, cooling provided by the bleed air 77 is necessary for operating of such engine components in the heightened temperature environments.

A remaining portion of the airflow 78 bypasses the LP compressor 24 and engine core 44 and exits the engine assembly 10 through a stationary vane row, and more particularly an outlet guide vane assembly 80, comprising a plurality of airfoil guide vanes 82, at the fan exhaust side 84. More specifically, a circumferential row of radially extending airfoil guide vanes 82 are utilized adjacent the fan section 18 to exert some directional control of the airflow 78.

Some of the air supplied by the fan 20 can bypass the engine core 44 and be used for cooling of portions, especially hot portions, of the engine 10, and/or used to cool or power other aspects of the aircraft. In the context of a turbine engine, the hot portions of the engine are normally downstream of the combustor 30, especially the turbine section 32, with the HP turbine 34 being the hottest portion as it is directly downstream of the combustion section 28. Other sources of cooling fluid can be, but are not limited to, fluid discharged from the LP compressor 24 or the HP compressor 26.

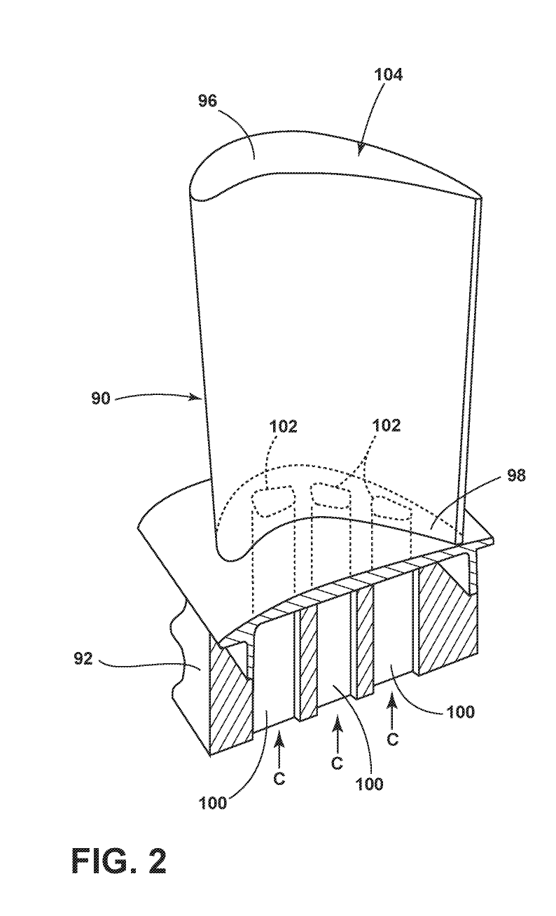

FIG. 2 is a perspective view of an engine component in the form of an airfoil 90, a platform 92, and a dovetail 94, which can mount to the disk 71 of the engine 10 of FIG. 1 as a rotating blade, or alternatively, can be a stationary vane. The airfoil 90 includes a tip 96 and a root 98, defining a span-wise direction therebetween. The airfoil 90 mounts to the platform 92 at the root 98. The platform 92 as shown is only a section, and can be an annular band for mounting a plurality of airfoils 90. The airfoil 90 can fasten to the platform 92, such as welding or mechanical fastening, or can be integral with the platform 92. The dovetail 94 couples to the platform 92 opposite of the airfoil 90, and can be configured to mount to the disk 71, or rotor 51 of the engine 10. The dovetail 94 can include one or more inlet passages 100, having an outlet 102 disposed at the root 98. It should be appreciated that the dovetail 94 is shown in cross-section, such that the inlet passages 100 are housed within the body of the dovetail 94. The inlet passages 100 can provide a cooling fluid flow C to an interior 104 of the airfoil 90 for cooling of the airfoil 90 in one non-limiting example. It should be understood that while the description herein is related to an airfoil, it can have equal applicability in other engine components requiring cooling such as film cooling. Such engine components can include but are not limited to, a shroud, a blade, a vane, or a combustion liner.

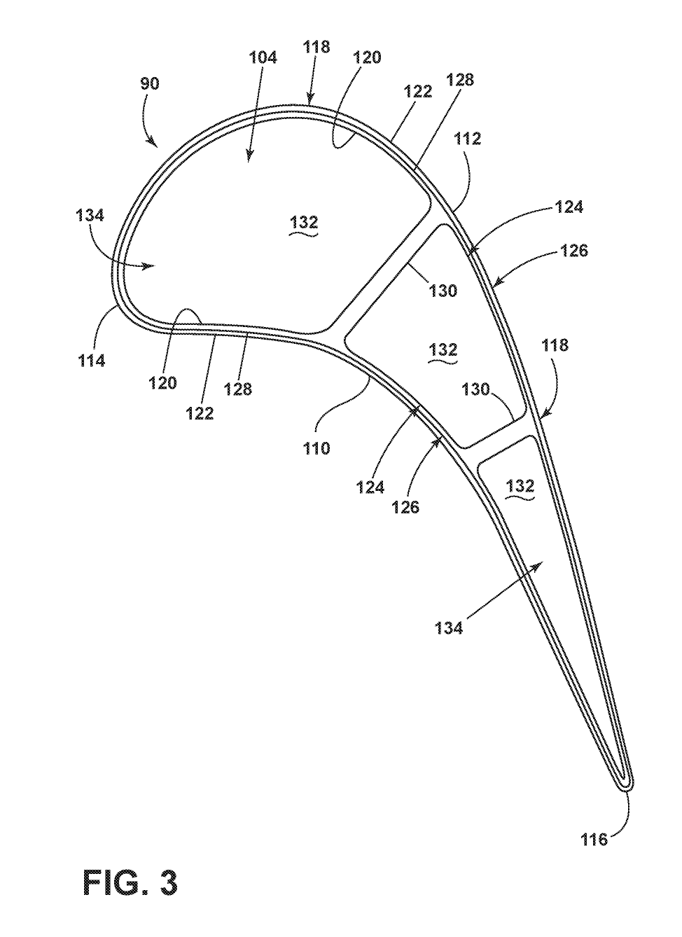

Referring to FIG. 3, the airfoil 90, shown in cross-section, has a concave-shaped pressure sidewall 110 and a convex-shaped suction sidewall 112 with a leading edge 114 and a trailing edge 116 defining a chord-wise direction therebetween. The pressure and suction sidewalls 110, 112 define an outer wall 118 bounding the interior 104. The airfoil 90 as an exemplary blade, rotates in a direction such that the pressure sidewall 110 follows the suctions sidewalls 112. Thus, as shown in FIG. 3, the airfoil 90 would rotate upward toward the top of the page. As a stationary vane, the airfoil 90 would not rotate.

The outer wall 118 includes an inner surface 120 and an outer surface 122. The inner surface 122 bounds the interior 104. The outer wall 118 is a two-layer wall, including a skin layer 124 and a porous layer 126. The skin layer 124 includes an exterior surface 128 disposed between the inner and outer surfaces 122. The porous layer 126 is provided on the exterior surface 128. Each layer 124, 126 can be manufactured using methods of formation individually or similar to one another. In one non-limiting example, the skin layer 124 can be cast, the porous layer 126 can be machined and placed on top of the skin layer 124. In another example, both layers 124, 126 can be made using additive manufacturing. It should be appreciated that the layers 124, 126 can be made by any known method including but not limited to, casting, machining, additive manufacturing, coating, or otherwise.

The layers 124, 126 can be made of similar materials, such as high strength superalloy metals, typically used for durability while minimizing the need for cooling. Such materials can include, but are not limited to nickel, cobalt, or iron based superalloys, ceramic matrix composites, steel, or refractory metals such as titanium. The porous layer 126 can be a porous material, defining a porosity, being permeable by a volume of fluid, such as air. The porous layer 126 can have a particular porosity to meter the flow of a fluid passing through the porous layer 126 at a predetermined rate. The porous layer 126 can be made of any of the materials described above, such that a porosity is defined. In one non-limiting example, the porous layer 126 can be an open cell porous metallic layer made of Ni, NiCrAlY, NiAl, or similar materials. The open cell porous layer can further be made of a nickel foam, for example.

Ribs 130 can be included in the interior of the airfoil 90. The ribs 130 can extend between the pressure sidewall 110 and the suction sidewall 112, coupling to or being integral with the skin layer 124. One or more interior passages 132 are defined by the ribs 130 and the outer wall 118, extending in the span-wise direction. A cooling air supply circuit 134 can be defined within the interior 104 for cooling the airfoil 90 or for providing a volume of fluid for exhausting form the airfoil 90 as a cooling film. The cooling air supply circuit 134 can be fed with the flow of cooling fluid C provided to the passages 132 form the dovetail 94 (FIG. 2). It should be understood that the span-wise orientations of the passages, ribs 130 or other geometries is non-limiting. The passages 132 and the cooling air supply circuits 134 defined thereby can be organized in three-dimensional space, such as extending in any combination of a span-wise, axial, radial, or any other direction.

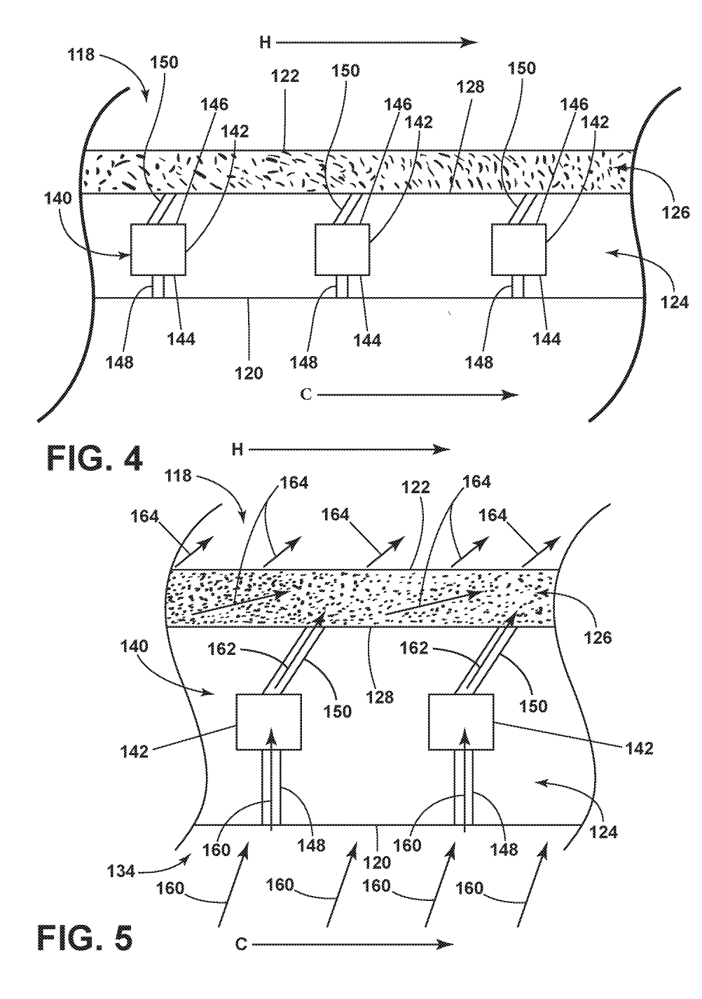

Referring to FIG. 4, an enlarged cross-sectional view of the outer wall 118 separates a cooling fluid flow C from a hot gas flow H, better illustrating the two-layer outer wall 118 including the skin layer 124 and the porous layer 126. A skin cooling circuit 140 can include at least one channel 142 formed in the skin layer 124. The channel can be any shape, such as having a rectilinear, oval, or circular cross-section in non-limiting examples. The channels 142 include a first closed end 144 and a second closed end 146. A supply hole 148 extends from the inner surface 120 and intersects the channel 142 at the first closed end 144. A feed hole 150 intersects the channel 142 at the second closed end 146 and connects to the porous layer 126. The supply hole 148 fluidly couples the interior 104 to the channel 142. The feed hole 150 fluidly couples the channel 142 to the porous layer 126.

The feed holes 150 can originate from any side of the channels 142, such as an outer surface, inner surface, or side walls as may define the channels 142. It should be understood that there can be any number of feed holes 150, having any orientation, shape, size, or organization. Similarly, the supply holes 148 should not be limited as shown. The supply holes can include any range of geometry, such as extending in three-dimensional space beyond the two-dimensional plane as shown in FIG. 4. Additional, the particular geometry of the supply holes 148 is not limited, except that they must originate on the inner surface 120. Furthermore, the interface of channels 142 with the porous layer 126 is exemplary, and need not be of an extent as shown. For example, the channels 142 can have any shape, such as a polygonal, oval, rectangular, circular, spherical, ellipsoidal, cubic, or otherwise, only limited that the channel 142 is fluidly coupled to the porous layer 126.

Referring now to FIG. 5, the cooling air supply circuit 134 fluidly couples to the porous layer 126 through the skin cooling circuit 140. A supply flow 160 is provided from the cooling air supply circuit 134 to the supply holes 148. The supply flow passes through the supply holes 148 to the interior of the channels 142. A feed flow 162 passes from the channels 142 through the feed holes 150 to the porous layer 126. From the porous layer 126, a porous flow 164 can pass within the porous material and exhaust therefrom to provide a film of cooling fluid along the outer surface 122 of the outer wall 118.

Increasing or decreasing the porosity of the porous layer 126 locally, can be used to increase or decrease the cooling film 164 provided from the porous layer 126 locally. Such a discrete adaptation of the porosity can, for example, be achieved through additive manufacturing. Such discrete porosity can be adapted to selectively increase or decrease the volume of cooling film provided from the porous layer 126, where increased or decreased film cooling is required. Porosity can be varied at different locations to provide different flow rates through different portions of the porous layer.

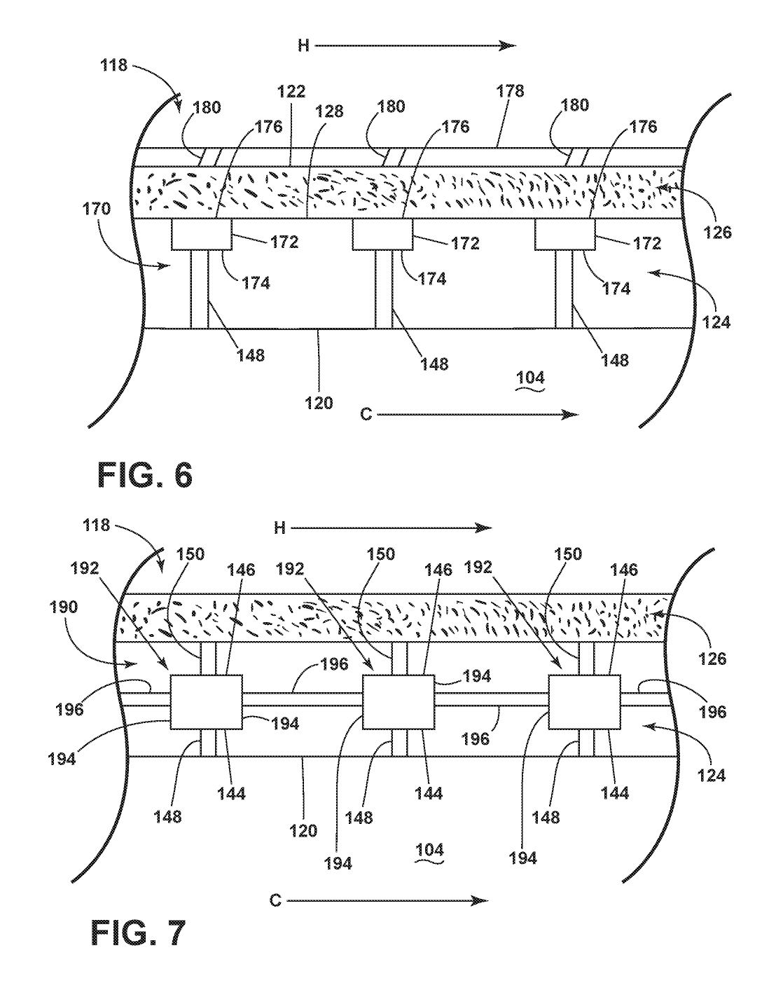

Referring to FIG. 6, an alternative skin cooling circuit 170 is illustrated. At least one channel 172 includes a closed end 174 and an open end 176. The open end 176 is adjacent to the porous layer 126. As can be appreciated, the feed hole 150 (FIG. 4) has been removed, directly coupling the channel 172 to the porous layer 126. As such, the open end 176 at the exterior surface of the skin layer 124 can provide a flow of cooling fluid to a greater area of the porous layer 126, or can improve manufacturing by removing the feed hole 150 intermediate between the channel 172 and the porous layer 126.

A coating 178 can be disposed on the outer surface 122 of the outer wall 118. Film holes 180 can extend through the coating 178, fluidly coupling the porous layer 126 to the exterior of the airfoil. Such film holes 180 can provide a flow of cooling fluid from the porous layer 126 along the coating 178 for surface film cooling of the airfoil or engine component. The film holes 180 can originate from any side of the channels 172, such as an outer or inner surface, or sidewalls, as may be defined by the shape of the channels 172. Similarly, there should be no limitation on the number, size, organization, shape, or orientation of the film holes 180.

It should be appreciated that the coating 178 used in conjunction with the porous layer 126 can provide for reduced cooling at the surface of the airfoil or the engine component, while incorporating a coating 178, such as a heat shield coating in one non-limiting example, to further improve the surface cooling while enabling the component to operate in heightened temperatures.

Referring now to FIG. 7, another exemplary skin cooling circuit 190 includes at least one channel 192. The channels 192 include sidewalls 194, in addition to the first and second closed ends 144, 146. The sidewalls 194 can be closed similar to the closed ends 144, 146. The sidewalls 194, in combination with the closed ends 144, 146 can form a squared or rectilinear shape for the channels 192. It is also contemplated that the channel 192 can be any other shape, such as a circle, where the closed ends 144, 146 and the sidewalls 194 are continuous.

One or more conduits 196 can intersect the sidewalls 194 of adjacent channels 192. The conduits 196 can be holes formed in the skin layer 124, in one non-limiting example. The conduits 196 can fluidly couple one or more channels 192 among the skin cooling circuit 190. The conduits 196 can provide for distributing the pressures of an airflow moving through the skin cooling circuit 190 deterministically throughout the skin cooling circuit 190. Deterministically distributing the pressures can provide a more controlledflow of cooling fluid to the porous layer 126 from multiple channels 192. Providing an controlled distribution of cooling fluid to the porous layer 126 can provide an controlled, deterministic flow of cooling fluid from the porous layer 126 to the exterior of the engine component. As such, a more uniform distribution of a surface cooling film can be provided across a larger area of the exterior of the engine component to provide for better component cooling. Furthermore, it is contemplated that the conduits 196 can only couple some of the adjacent channels 192 of the skin cooling circuit 190, to provide an increased flow of cooling fluid to portions of the porous layer 126, which may otherwise receive a lesser airflow pressure.

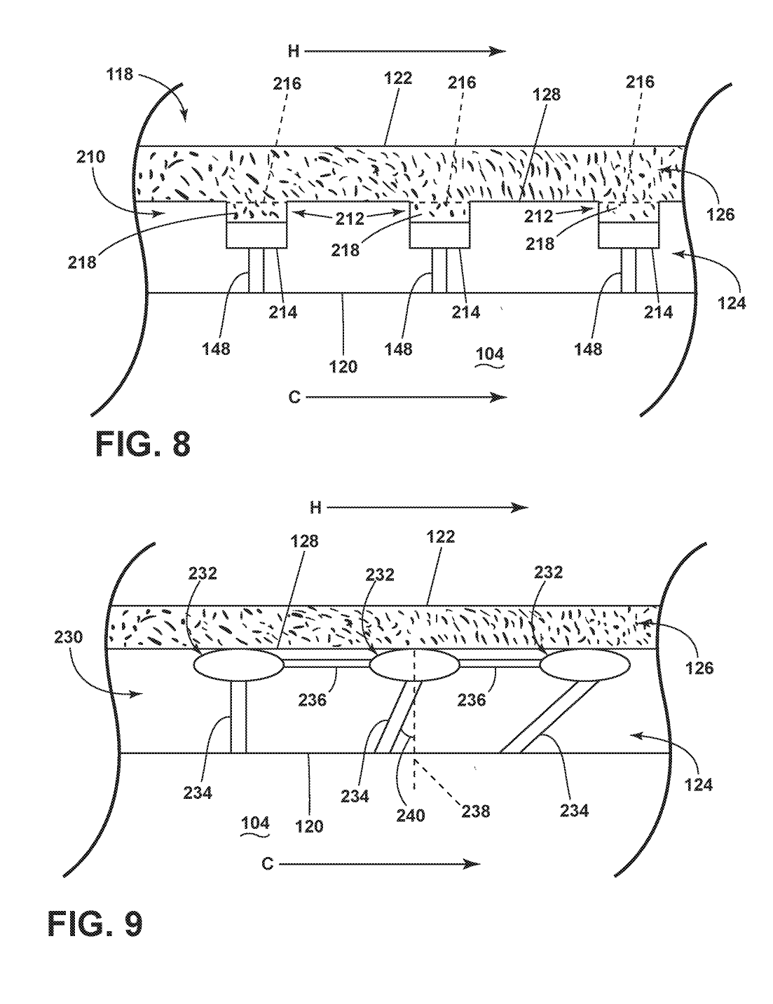

Referring now to FIG. 8, another exemplary skin cooling circuit 210 is illustrated including at least one channel 212, illustrated as three channels 212. The channels 212 include a closed end 214 and an open end 216, having the closed end 214 positioned toward the inner surface 120 and the open end 216 positioned toward the outer surface 122. The supply hole 148 can intersect the closed end 214. The supply hole 148 fluidly couples the interior 104 to the channels 212.

A portion 218 of the porous layer 126 can extend into channels 212 through the open ends 216. The portion 218 can receive a flow of cooling fluid from the channels 212 and provide the cooling fluid flow throughout the porous layer 126. Additionally, the portion 218 can provide for an improved bonding of the porous layer 126 to the skin layer 124 at the channels 212.

Furthermore, the local porosity of the porous layer 126 can be adapted to draw a greater amount of cooling fluid at the channels 212 and provide the cooling fluid deterministically throughout the porous layer 126 to provide controlled, determined film cooling from the porous layer 126 to the exterior of the engine component or airfoil.

Referring now to FIG. 9, another exemplary skin cooling circuit 230 is illustrated having at least one channel 232. The channels 232 as shown are elliptical, having only a portion of the channel 232 adjacent to the porous layer 126. A supply hole 234 intersects the channels 232. At least one conduit 236 can intersect adjacent channels 232. The conduits 236 can interconnect multiple channels 232 to define multiple discrete skin cooling circuits 230 within the skin layer 124.

A channel axis 238 can be defined from the channel 232, being normal to the inner surface 120 or the exterior surface 128. The supply hole 234 can be angled relative to the channel axis 238 to define a supply hole angle 240. The supply hole angle 240, for example, can be between 5 degrees and 75 degrees in any cross-sectional representation, and can vary among one skin cooling circuit 230. The supply hole 234 fluidly couples the channels 232 to the interior 104 of the airfoil or engine component. The supply hole angle 240 for each supply hole 234 can be adapted modify the flow coefficient, or flow characteristics of a flow of cooling fluid moving in a direction along the inner surface 120. Thus, the supply hole 234 can be angled to improve the flow received from the interior 104 and provided to the porous layer 126 based upon the directionality of the flow provided from the interior 104.

Additionally, the surface area of the porous layer 126 open to the channel 232 can be varied by the position and geometry of the channel 232. Such a position and geometry can be used to meter the flow of fluid provided to the porous layer 126 from the skin cooling circuit 230.

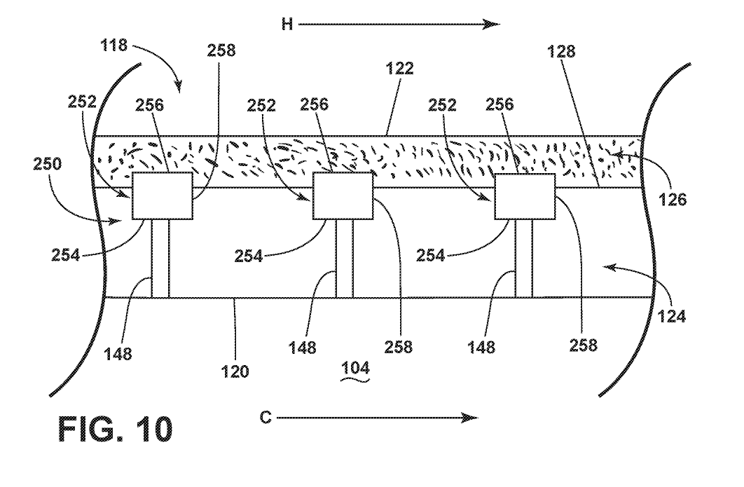

Referring now to FIG. 10 another exemplary skin cooling circuit 250 is illustrated having at least one channel 252. The channels 252 include a closed end 254 and an open end 256, having sidewalls 258 between the ends 254, 256. The supply hole 148 interests the closed end 254 to fluidly couple the interior 104 to the channels 252. The channels 252 can be at least partially defined within the porous layer 126, such that a portion of the porous layer 126 includes a decreased thickness where the channels 252 are partially formed within the porous layer 126.

Forming the channels 252 at least partially within the porous layer 126 can provide increased surface area where a flow of cooling fluid provided from the channel 252 can be provided to the porous layer 126. Such a surface area can be increased or decreased by increasing or decreasing the amount of the channel 252 defined within the porous layer 126 as well as adapting the geometry of the channels 252. Adapting the geometry can include increasing the length or area of the sidewalls 258 or the open end 256, as well as the overall size of the channels 252.

It should be understood that the exemplary skin circuits as illustrated are not limiting, and can selectively combine or eliminate elements among separate embodiments to form additional exemplary skin circuits utilizing the features as described herein. Similarly, the rectilinear geometry as illustrated should not be construed as limiting.

A method of cooling an airfoil 90 or other engine component can include passing a cooling airflow through the interior 104 of the airfoil 90 to a channel in a skin layer 124, then passing the cooling airflow to a porous layer overlying the skin layer 124. The method can further include passing the cooling airflow through a portion of the porous layer 126 which extends into the channel. For such an example, see FIG. 8. Additionally, the method can further include passing the cooling airflow through at least one hole fluidly connecting the channel to the porous layer 126. Such a hole can include, for example, the feed hole 150 of FIG. 4 or FIG. 7.

It is contemplated that the skin layer, the porous layer, the engine component, and cooling circuit structures described herein can be made with additive manufacturing. Additive manufacturing, such as 3D printing, can be used to form complex cooling circuit designs, having shaping or metering sections, complex circuits, holes, conduits, channels, or similar geometry, which is otherwise difficult to achieve with other manufacturing methods like drilling or casting. Additionally, the porous layer can be formed with additive manufacturing. Typical methods for forming porous metals can result in uneven porosity among areas of the porous metals. Utilizing additive manufacturing can enable a manufacturer to achieve a more uniform porosity along the entire porous structure. Furthermore, such manufacturing can provide a more precisely made product, having a higher yield as compared to other manufacturing strategies.

It should be appreciated that the airfoil or engine component, utilizing at least one porous layer and a skin layer bonded to or built over the porous layer provides for even cooling distribution for a flow of cooling fluid. An additive manufacturing build of the regions could provide a precise distribution, particularly permitting an even porosity for the porous layer(s). Additionally, the use of additive manufacturing can permit particular shaping or tailoring of the skin cooling circuits to control the flows being provided therethrough. Such shaping can include exit shaping to particularly direct or spread the cooling fluid. Such exit shaping can be done in the porous layer or a coating disposed thereon. Utilizing such a porous material permits the flow of a fluid through the engine component, while retaining less heat to remain cooler. As such, the cooling, such as surface film cooling, provided through the walls of such engine components is enhanced. The enhanced cooling reduces the required flow of cooling fluid, such as up to 30-50%. Such a reduction can increase engine efficiency. Furthermore, reduced blowing ratios can obtain better surface film cooling to increase component lifetime or reduce required maintenance.

It should be appreciated that application of the disclosed design is not limited to turbine engines with fan and booster sections, but is applicable to turbojets and turbo engines as well.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. An airfoil for a turbine engine, the airfoil comprising:
an outer wall having an outer surface and an inner surface bounding an interior space, the outer wall defining a pressure side and a suction side extending axially between a leading edge and a trailing edge and extending radially between a root and a tip, the outer wall comprising;
a skin layer having an exterior surface;
at least one porous layer provided on the exterior surface of the skin layer; and
at least one skin cooling circuit comprising at least one channel formed in the skin layer and fluidly coupled to the porous layer; and
at least one cooling air supply circuit located within the interior and fluidly coupled to the at least one channel.

2. The airfoil of claim 1 further comprising at least one hole fluidly coupling the at least one channel to the porous layer.

3. The airfoil of claim 1 wherein the at least one channel has at least one of a closed end and an open end.

4. The airfoil of claim 3 wherein the open end opens onto the porous layer.

5. The airfoil of claim 4 wherein a portion of the porous layer extends into the channel.

6. The airfoil of claim 5 wherein a portion of the channel is provided in the porous layer.

7. The airfoil of claim 4 wherein the at least one channel comprises multiple channels, with at least some of the multiple channels having a portion formed in the porous layer.

8. The airfoil of claim 7 wherein at least some of the multiple channels are formed solely in the skin layer.

9. The airfoil of claim 3 further comprising a hole fluidly coupling the closed end to at least one of the porous layer and the supply circuit.

10. The airfoil of claim 1 further comprising separate holes, one of which fluidly couples the channel to the porous layer and the other fluidly coupling the channel to the supply circuit.

11. The airfoil of claim 1 further comprising a coating disposed on the porous layer.

12. The airfoil of claim 11 further comprising a hole passing through the exterior coating and fluidly coupling to the porous layer.

13. The airfoil of claim 1 wherein the channel has at least one of a rectilinear, oval, or circular cross section.

14. An engine component for a turbine engine, which generates a hot fluid flow, and provides a cooling fluid flow, comprising:
a wall separating the hot fluid flow from the cooling fluid flow and having a first surface along with the hot fluid flow in a hot flow path and a second surface facing the cooling fluid flow, the wall comprising;
a skin layer having an outer surface;
at least one porous layer provided on the outer surface of the skin layer; and
at least one skin cooling circuit comprising at least one channel formed in the skin layer;
wherein the cooling fluid flow is fluidly coupled to the porous layer through the channel of the skin layer.

15. The engine component of claim 14 further comprising at least one hole fluidly coupling the at least one channel to the porous layer.

16. The engine component of claim 14 wherein the at least one channel has at least one of a closed end and an open end.

17. The engine component of claim 16 wherein the open end opens onto the porous layer.

18. The engine component of claim 17 wherein a portion of the porous layer extends into the channel.

19. The engine component of claim 18 wherein a portion of the channel is provided in the porous layer.

20. The engine component of claim 17 wherein the at least one channel comprises multiple channels, with at least some of the multiple channels having a portion formed in the porous layer.

21. The engine component of claim 20 wherein at least some of the multiple channels are formed solely in the skin layer.

22. The engine component of claim 16 further comprising a hole fluidly coupling the closed end to at least one of the porous layer and the cooling fluid flow.

23. The engine component of claim 14 further comprising separate holes, one of which fluidly couples the channel to the porous layer and the other fluidly coupling the channel to the cooling fluid flow.

24. The engine component of claim 14 further comprising a coating disposed on the porous layer.

25. The engine component of claim 24 further comprising a hole passing through the exterior coating and fluidly coupling to the porous layer.

26. The engine component of claim 14 wherein the channel has at least one of a rectilinear, oval, or circular cross section.

27. A method of cooling an engine component comprising passing a cooling airflow through an interior of the airfoil to a channel in a skin layer, and then to a porous layer overlying the skin layer.

28. The method of claim 27 wherein passing the cooling air from the channel to the porous layer comprises passing the cooling airflow through a portion of the porous layer extending into the channel.

29. The method of claim 27 wherein passing the cooling air from the channel to the porous layer comprises passing the cooling airflow through at least one hole fluidly connecting the channel to the porous layer.
